(19) United States
(12) Patent Application Publication
(10) Pub. No.: US 2026/0252703 A1
(43) Pub. Date: Aug. 27, 2026

(54) PROCESS VULNERABILITY ASSESSMENT

(71) Applicant: International Business Machines Corporation, Armonk, NY (US)

(72) Inventors: James David CLEAVER, Grose Wold (AU); Michael James MCGUIRE, North Kellyville (AU); Tamera ABOUALY, Etobicoke (CA)

(21) Appl. No.: 19/060,032

(22) Filed: Feb. 21, 2025

(51) Int. Cl. G06F 21/57; G06Q 10/0633

(52) U.S. Cl. CPC G06F 21/577; G06F 2221/034; G06Q 10/0633

(57) ABSTRACT

Method and apparatus for analyzing operational processes to detect vulnerabilities are provided. The method includes generating a documented workflow by processing a plurality of unstructured documents associated with an operational process, generating an implemented workflow by analyzing source code that implements the operational process in a computing system, generating an executed workflow by processing real-world execution data for the operational process, analyzing the documented workflow, the implemented workflow, and the executed workflow to identify one or more inconsistencies among the workflows and one or more exploits within the operational process, and generating one or more recommended actions to remedy at least one of the one or more identified inconsistencies or the one or more identified exploits.

### BACKGROUND

The present disclosure relates to workflow assessment and, more specifically, to analyzing various operation processes to detect vulnerabilities and inconsistencies and generating corresponding remedial actions.

### SUMMARY

One embodiment presented in this disclosure provides a method, including, generating a documented workflow by processing a plurality of unstructured documents associated with an operational process, generating an implemented workflow by analyzing source code that implements the operational process in a computing system, generating an executed workflow by processing real-world execution data for the operational process, analyzing the documented workflow, the implemented workflow, and the executed workflow, comprising: comparing the documented workflow, implemented workflow, and the executed workflow to identify one or more inconsistencies among the workflows, accessing a library of exploit patterns to retrieve a plurality of prompts, applying the plurality of prompts to at least one of the documented workflow, the implemented workflow, or the executed workflow to generate a plurality of responses, and analyzing the plurality of responses to identify one or more exploits within the operational process, and generating one or more recommended actions to remedy at least one of the one or more identified inconsistencies or the one or more identified exploits.

Other embodiments in this disclosure provide computer-readable media containing computer program code that, when executed by operation of a computer system, performs operations in accordance with one or more of the above methods, as well as systems comprising one or more memories collectively containing one or more programs, and one or more processors, where the one or more processors are configured to, individually or collectively, perform an operation in accordance with one or more of the above methods.

### BRIEF DESCRIPTION OF THE DRAWINGS

FIG. 1 depicts an example computing environment for the execution of at least some of the computer code involved in performing the inventive methods.

FIG. 2 depicts an example workflow for process vulnerability assessment and remedial action recommendation, according to some embodiments of the present disclosure.

FIG. 3 depicts an example method for generating a documented workflow for an operational process, according to some embodiments of the present disclosure.

FIG. 4 depicts an example method for generating an implemented workflow for an operational process, according to some embodiments of the present disclosure.

FIG. 5 depicts an example method for generating an executed workflow for an operational process, according to some embodiments of the present disclosure.

FIGS. 6A and 6B depict an example method for identifying vulnerabilities and inconsistencies in received workflows and generating reports with recommended actions, according to some embodiments of the present disclosure.

FIG. 7 is a flow diagram depicting an example method for process vulnerability assessment and remedial action recommendation, according to some embodiments of the present disclosure.

### DETAILED DESCRIPTION

Many industries, particularly in the service sector, rely on predefined operational processes to ensure consistency and compliance. For example, when a customer calls a bank to update his or her credit card contact information, a standard process is typically in place to validate the caller’s identity through specific security checks. However, these processes may include vulnerabilities, including but not limited to, incomplete validation of user credentials, insufficient separation of duties, or improperly configured thresholds for approval. These vulnerabilities or gaps leave these predefined operational processes open to exploitation. Additionally, inconsistencies may arise between the designed process (e.g., how it is intended to function) and the process as it is executed in practice, such as deviations from documented workflows or manual workarounds introduced by operators. These vulnerabilities and inconsistencies may be exploited either intentionally by malicious actors seeking to bypass security controls, or accidentally through errors made by employees or automated systems due to unclear instructions.

Such exploitation may result in damages, such as financial losses or breaches of sensitive information. With the increasing adoption of Robotic Process Automation (RPA), the impact of these vulnerabilities is further magnified. As used herein, RPA refers to the mechanism where artificial intelligence (AI) and/or other automated techniques are used to assist in executing operational processes. RPA improves efficiency by automating repetitive and rule-based tasks, but it also introduces challenges since judgment and discretion often applied by human operators are removed when relying solely on predefined rules. Therefore, there is an increasing need to identify and address vulnerabilities in operational processes before the implementation of RPA. Proactively addressing these issues can lower risks and ensure the secure and effective integration of automation technologies.

Embodiments of the present disclosure provide methods, systems, and apparatuses for analyzing operational processes to detect vulnerabilities and inconsistencies and generating corresponding remedial actions. Unlike conventional approaches, which often rely on manual reviews or static testing methods, the present disclosure introduces a dynamic and automated framework that provides higher accuracy and adaptability in identifying gaps and risks in predefined operational processes.

More specifically, in some embodiments, the disclosed system may generate structured workflows for an operational process by processing various types of data. For example, the system may first process unstructured documents (e.g., guidelines, operational manuals, operational policies) to generate a documented workflow in a structured format (e.g., business process model and notation (BPMN)). The system may then analyze the codebase of the operational process, using static code analysis tools or control-flow extraction techniques, to produce an implemented workflow. Finally, the system may process execution data, collected through process mining and task mining tools, to generate an executed workflow. As used herein, the documented workflow represents how the operational process was originally designed. The documented workflow may serve as the intended blueprint or standard for subsequent comparison. As used herein, the implemented workflow captures the technical implementation of the process, showing how it has been translated from the original design into executable system logic. As used herein, the executed workflow represents how the operational process is actually being executed in real-world scenarios. The executed workflow may reflect an operator’s real behaviors during execution, including variations and changes induced in practice.

With these workflows for the operational process, in some embodiments, the disclosed system may access a library of exploit patterns to retrieve prompts that can be used to test the workflows for vulnerabilities. These prompts are specially designed to probe workflows for specific vulnerabilities and risks, such as incomplete validation steps, unclear instructions for security checks, or improperly configured approval thresholds. In some embodiments, these prompts may be generated by a generative AI (GenAI) model (e.g., large language model (LLM)) through expert inputs. The system may use a Modular Reasoning, Knowledge, and Language (MRKL) architecture to apply the retrieved prompts to the workflows and detect vulnerabilities and inconsistencies. This process may involve comparing the workflows to detect discrepancies, such as validation steps specified in the documented workflow but not executed in real practice, and using the prompts from the library to interrogate the workflows by asking targeted questions and generating responses. These responses may then be analyzed to uncover vulnerabilities or gaps in the system, such as improperly configured thresholds or missing security checks. With the detected vulnerabilities and inconsistencies, the disclosed system may generate recommendations to address these risks, such as realigning the documented, implemented, and executed workflows, improving process controls, or introducing monitoring mechanisms to prevent future exploitation of similar vulnerabilities.

By integrating these capabilities, the disclosed system provides a dynamic framework for analyzing predefined operational processes and identifying their underlying vulnerabilities and inconsistencies. With these issues identified and remedied, the risks associated with these operational processes are significantly reduced, even with the incorporation of RPA, where human judgment and discretion are significantly reduced during execution.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

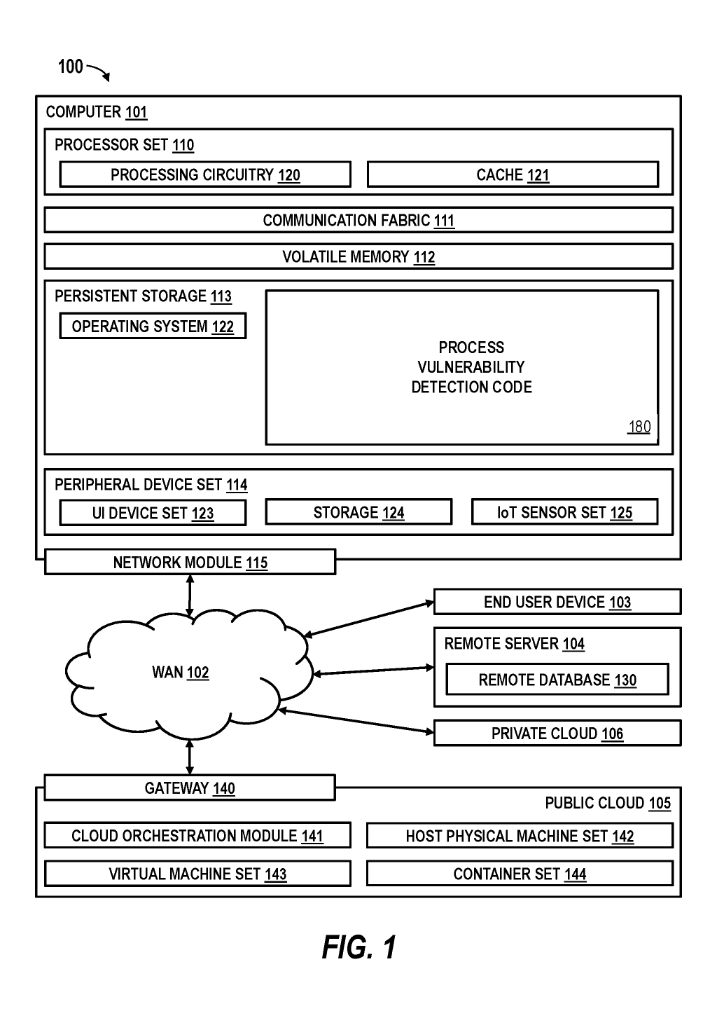

FIG. 1 depicts an example computing environment 100 for the execution of at least some of the computer code involved in performing the inventive methods.

Computing environment 100 contains an example of an environment for the execution of at least some of the computer code involved in performing the inventive methods, such as Process Vulnerability Detection Code 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private cloud 106 and public cloud 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

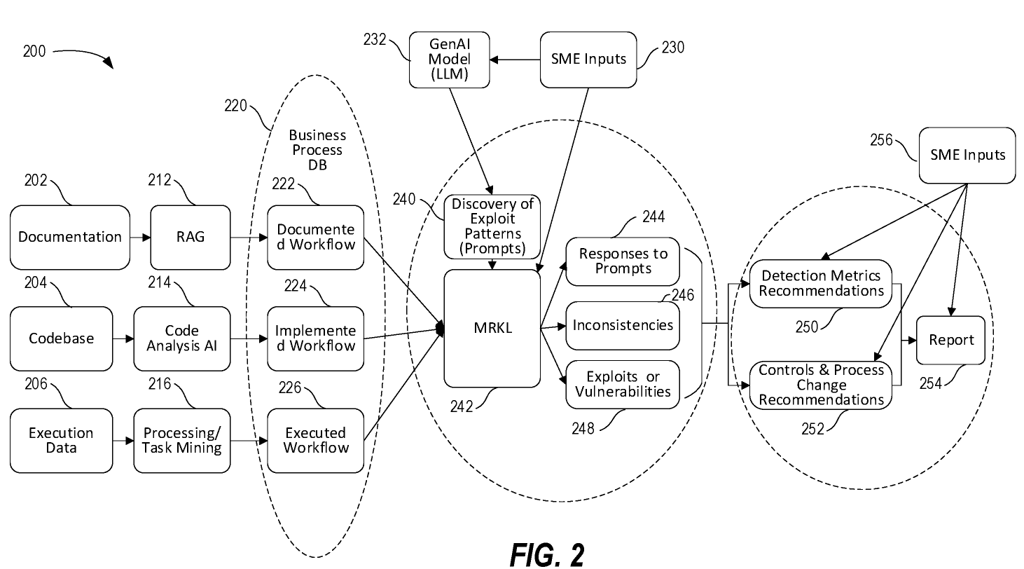

FIG. 2 depicts an example workflow 200 for process vulnerability assessment and remedial action recommendation, according to some embodiments of the present disclosure.

The example workflow 200 illustrates a method for detecting vulnerabilities and inconsistencies in defined business processes (also referred to in some embodiments as operational processes). As used herein, a business or operational process refers to a structured set of activities or tasks designed to achieve a specific organizational goal or outcome. Examples may include, but are not limited to, customer onboarding, loan application & approval workflows in banking, or claims processing in insurance.

These processes typically involve a combination of written documents that outline the process design, code implemented in computing systems or engines for automated execution, and records generated during real-world execution that capture the actual process flows. Gaps or inconsistencies may arise between the documented design, the coded implementation, and the executed workflow in practice. These issues can lead to significant risks, such as financial losses, breaches of sensitive data, operational inefficiencies, or non-compliance with regulatory standards. To address these challenges and other relevant concerns, the present workflow 200 provides a systematic approach to identify and remedy these vulnerabilities and inconsistencies. By analyzing documented, implemented, and executed workflow using prompts generated from exploit patterns and generating actionable recommendations, the method improves the overall accuracy and reliability of the operational processes.

As depicted, unstructured documentation 202 is processed through a Retrieval-Augmented Generation (RAG) module 212 to generate a structured documented workflow 222. Examples of such unstructured documents 202 include, but are not limited to, operational manuals, standard operating procedures, guidelines, policies, and regulatory compliance documents. These documents describe the intended design of a business process and are typically presented in an unstructured format, such as natural language plain text or portable document formats (PDFs). The unstructured format makes it difficult to analyze the workflow directly.

As illustrated, the RAG module 212 is configured to transform the unstructured information into a structured workflow 222. In some embodiments, the RAG module 212 may first perform semantic analysis on the text, using a language model (e.g., large language model (LLM)) to extract entities, actions, decision points, and relationships. For example, in a document outlining a loan approval process, the RAG module 212 identifies steps (or actions) such as “validate applicant identity,” “review financial history,” and “approve or reject application.” These steps may then be semantically categorized and mapped to their corresponding roles and conditions within the loan approval process.

Next, in some embodiments, the RAG module 212 may convert the extracted semantic information into a machine-readable vectorized representation. This process may involve encoding each text segment into a high-dimensional vector space (e.g., three-dimensional (3D)). The vectorized representations capture the semantic relationships and contextual distinctions between the document’s elements, and can be used for subsequent pattern recognition.

Using the embedded semantic information, the RAG module 212 may then normalize the extracted data into a structured business process model and notation (BPMN) format. This may include organizing the identified process steps into a standardized format, defining the transitions between steps, specifying roles, and mapping decisions points. For example, a written request for verifying an applicant’s identity (e.g., within a loan approval process) may be transformed into a BPMN model, where tasks like “Input Credentials,” “Check Database Records,” and “Approval or Reject” are connected with defined decision paths and flow logic. As used herein, the resulting documented workflow 222 represents how the business process is designed in the original documentation. The workflow 222 provides a structured and machine-readable foundation for further analysis (e.g., vulnerability assessment).

After a business process has been defined in written documents, certain tasks within the process do not require manual review or execution. Instead, these tasks may be automated and executed by computing systems or engines. To achieve this, a set of instructions may be encoded in source code, configuration files, and other system components. These instructions define the logic, conditions, and actions necessary for the process to function automatically (e.g., which replaces or augments manual operations). For example, in a banking operation, a loan approval process may be implemented as a series of coded steps that validate an applicant’s identity data, assess his or her creditworthiness (e.g., credit scores), and make approval decisions.

As depicted, an implemented workflow 224 is generated by analyzing the codebase 204 directly related to the business process being examined. The codebase 204 under analysis may include source code, configuration files, and other system components that define how the process is implemented for automated execution. To extract and organize this information, AI-powered analysis techniques 214 are used. These techniques includes, but are not limited to, static code analysis for identifying control flows and decision points, natural language processing (NLP) for interpreting code comments, and data flow analysis for tracing how inputs are processed and decisions are made. For example, static code analysis may identify sequences such as “if-else” conditions and loops, while data flow analysis may map dependencies between variables and tasks. As illustrated, the extracted logic is then transformed into a structured BPMN format, forming an implemented workflow 224. As used herein, the implemented workflow 224 represents the business process as it is encoded in the computing system. The workflow may capture tasks and decision points within the business process, as well as transitions and relationships between these tasks and decision points during implementation. For example, a loan approval process in the codebase may be modeled in BPMN with steps such as “Retrieve Applicant Details,” “Validate Income Threshold,” and “Approve or Reject Application,” along with conditional transitions and loopback paths for error handling.

For a process that has been designed in written documentation 202 and/or implemented into a computing system, the execution of the designed process in real-world scenarios generates execution data 206 that records the actual operational behavior of the process. This execution data 206 provides a detailed account of how the process is implemented in practice, including any deviations or exceptions introduced during execution. The execution data 206 may include, but are not limited to, system logs, timestamps, event traces, user activity logs, transactional records, and any relevant operational metadata that captures the sequence and outcome of executed tasks.

As depicted, an executed workflow 226 is generated by processing the execution data 226 using task mining and/or process mining tools 216. These techniques analyze the recorded events to identify decision points, map the dependencies between tasks, and reconstruct the flow of activities to generate the executed workflow 226. As used herein, the resulting executed workflow 226 represents how the business process is executed in real-world scenarios. The executed workflow 226 may provide details about practical aspects of the business process, such as bottlenecks, skipped steps, rework loops, and timing irregularities that may not align with the original design or implementation. In some embodiments, the executed workflow may be normalized into a structured format like BPMN. This format organizes the real-world process data into tasks and makes it analyzable and comparable to the documented and implemented workflows 222 and 224.

As depicted, the generated documented workflow 222, implemented workflow 224, and executed workflow 226 for a specific process (e.g., a loan approval process) are all stored in the process Database (DB) 220 as structured, machine-readable entities. The centralized repository enables efficient retrieval of the workflows by the Modular Reasoning Knowledge and Language (MRKL) system 242 for vulnerability assessments. Whenever an assessment is initiated, the MRKL system 242 can access the documented, implemented, and executed workflows 222, 224, and 226 directly from the process DB 220. This allows the system 242 to efficiently apply prompts from exploit patterns, perform comparisons, and identify vulnerabilities or inconsistencies without requiring manual inputs or additional preprocessing. The centralized repository also maintains the workflows 222, 224, and 226 consistent and up-to-date. As new documentation 202, updates to the codebase 204, and/or new execution data 206 are created, the corresponding workflows 222, 224, and 226 may be modified and refined to align with the updated information.

The MRKL system 242 is configured to analyze workflows and identify vulnerabilities in a process using detected exploit patterns. As depicted, the MRKL system 242 is connected directly to the process DB 220 to retrieve the documented, implemented, and executed workflows 222, 224, and 226 for a specific process (e.g., load approval process). Using these workflows, the MRKL system 242 applies prompts from the discovery of exploit patterns 240 to identify potential gaps, inconsistencies, and/or vulnerabilities within the process.

The discovery of exploit patterns 240 (also referred to in some embodiments as the library of exploit patterns) is a prebuilt repository that contains a wide range of prompts specifically designed to test various processes and identify potential vulnerabilities or exploits. These prompts are created using a generative AI (GenAI) model 232 (e.g., LLM) based on inputs 230 provided by subject matter experts (SMEs) in relevant fields (e.g., business process security, compliance, and operations). The prompts are designed to probe the workflows (e.g., the documented workflow 222, the implemented workflow 224, and the executed workflow 226) systematically and expose weaknesses and/or areas of misalignment within the business process.

In some embodiments, the library of exploit patterns 240 may grow dynamically over time. As the system is used and additional threats or vulnerabilities are discovered, new prompts may be generated and added to the library 240. The dynamic evolving capability ensures that the MRKL system 242 stays up-to-date and effectively addresses emerging risks within the generated workflows. Various techniques may be used in prompt generation, including static lists, interview-based prompt techniques, chain of thought, and/or tree of thought. The prompts in the library 240 may range from general to highly specific, depending on the context of the business process being analyzed. Examples of prompts include: “What is the clip level for loan approvals?” and “How many approvals are within 5% below the clip level?”

As depicted, the MRKL system 242 connects to the library of exploit patterns 240 to retrieve relevant prompts based on the workflows 222, 224, and 226 it analyzes. The MRKL system 242 may first compare the retrieved workflows 222, 224, and 226 with each other to identify inconsistencies 246. As discussed above, the documented workflow 222 represents the process as designed, the implemented workflow 224 represents the process as coded in computing systems, and the executed workflow 226 represents the process as performed in real-world conditions. The comparison among workflows enable the MRKL system 242 to detect discrepancies 246, such as missing validation steps in the implemented workflow, deviations in execution behavior due to manual interventions, or unaligned approval thresholds across workflows. These identified discrepancies or inconsistencies 246 reveal potential risks within the business process, which could result in various issues, such as operational inefficiencies, security breaches, and/or compliance failures.

After comparing workflows, in some embodiments, the MRKL system 242 may use the retrieved prompts from the library of exploit patterns to probe the workflows. The prompts may be applied to specific workflow elements to generate responses 244. For example, a prompt like “What is the clip level for loan approval?” may be used to evaluate whether the documented, implemented, and/or executed workflows consistently apply approval thresholds. The responses 244 to these prompts provide valuable data illustrating how the workflows align or deviate from the intended design. The MRKL system 242 may further analyze these responses 244 to identify gaps or exploits, such as incomplete validations, improperly configured conditions, or other potential vulnerabilities exploitable by malicious actors.

In some embodiments, the MRKL system 242 may rely on three specialized modules to perform its designated functions: a knowledge module, an expert module (also referred to in some embodiments as a reasoning module), and a language module. The knowledge module is configured to retrieve the documented, implemented, and executed workflows from the process DB 220, and fetch relevant prompts from the library of exploit patterns 240. The reasoning module is designed to apply the retrieved prompts to the workflows, simulating queries and generating corresponding responses. The language module is configured to analyze the responses generated from the prompts and detect vulnerabilities, gaps, and exploits by evaluating how workflows behave under the probing of the prompts.

Based on the generated responses 244, the detected inconsistencies 246 and/or exploits 248, the MRKL system 242 generates remedial actions to address the identified risks. As depicted, these actions are categorized into two types: detection metrics recommendations 250 and control & process change recommendations 252. In some embodiments, the detection metrics recommendations 250 may introduce monitoring mechanisms to track potential vulnerabilities in real-time. These recommendations may define certain indicators to identify future deviations or anomalies in process execution. In some embodiments, the control & process change recommendations 252 may include actions to align the documented, implemented, and executed workflows. In embodiments where vulnerabilities of the business process are detected, the recommendations 252 may involve modifying control mechanisms to fill the gaps, such as refining loan approval thresholds, strengthening validation steps, and/or implementing stricter role-based access controls.

As depicted, all the recommendations 250 and 252 generated by the MRKL system 242 are compiled into a report 254. The report 254 serves as a detailed summary of the analysis. Once generated, the report 254 is sent for review by experts or other relevant stakeholders. In some embodiments, the report 254 may further include the detected inconsistencies 246 and vulnerabilities 248. In some embodiments, subject matter experts (SMEs) in relevant fields like security, compliance, or operational management may evaluate the findings and recommendations. In some embodiments, these experts may provide additional inputs 256 or adjustments to the proposed actions to ensure these actions align with compliance requirements and organizational goals. For example, a SEM may refine a recommended change in validation logic to better suit the technical or regulatory context of the business process. In some embodiments, following the expert review, some or all of the remedial actions may be implemented automatically within the operational system, such as updating validation thresholds or deploying monitoring mechanism to detect future vulnerabilities.

The generation of the documented workflow 222, implemented workflow 224, and executed workflow 226, may be performed either in parallel or sequentially. In a parallel setup, each type of workflow may be generated simultaneously using separate modules or computational resources. This approach may reduce processing time and work for environments with distributed computing capabilities. Alternatively, in a sequential setup, the workflows may be generated one after another. The overall process for generating workflows and performing vulnerability detection may be conducted using either a centralized system or a distributed system across multiple computing nodes.

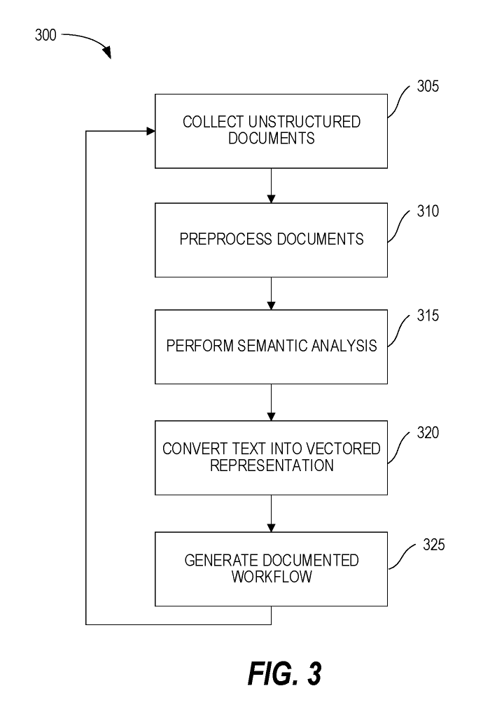

FIG. 3 depicts an example method 300 for generating a documented workflow for an operational process, according to some embodiments of the present disclosure. The example method may be performed by any computing device or system capable of processing unstructured documents and transforming these documents into structured workflows. This includes computing system 100 as depicted in FIG. 1, and the RAG module 212 as depicted in FIG. 2, or other computing frameworks with natural language processing capabilities. The disclosed method may be implemented in centralized architectures, where all processing occurs within a single computing environment, or in distributed architecture, where different components of the method are executed across multiple nodes or services.

At block 305, a computing device collects unstructured documents (e.g., 202 of FIG. 2) related to a business process (also referred to in some embodiments as operational process). These unstructured documents may describe the design and intended flow of the business process in plain language. The documents may include operational manuals, standard operating procedures, policy documents, and compliance guidelines. For a loan approval process in a banking institution, the collected unstructured documents for this process may include load application policies (e.g., which outline the eligibility criteria for load applicants), approval process guidelines (e.g., which detail the step-by-step procedure for reviewing applications, performing credit checks, and determining land approval or rejection), regulatory compliance rules (e.g., which specify the legal and financial standards), and relevant escalation procedures (e.g., which define how exceptions or edge cases should be handled).

At block 310, the computing system performs text preprocessing to prepare the documents for subsequent semantic analysis and transformation into a structured workflow. In some embodiments, the preprocessing may include cleaning the documents by removing noise, such as irrelevant metadata, formatting artifacts (e.g., page numbers, headers, footers), and redundant content (e.g., duplicated paragraphs or sections). For example, a loan approval policy document may contain extraneous text like “Page 1 of 10” or repeated disclaimers that are not relevant to the process description. These irrelevant content may be removed from the document to speed up subsequent analysis. In some embodiments, the preprocessing may also include segmenting the text into manageable chunks (e.g., sentences or paragraphs) and normalizing the text into a unified format (e.g., converting all text into lowercase, resolving synonyms or abbreviations, and applying stemming or lemmatization). For example, a policy documents may be segmented into sections like “Eligibility Criteria,” “Approval Steps,” and “Escalation Rules.” In documents where “credit score threshold” and “credit score limit” are used interchangeably, the two terms may be normalized to a consistent term like “score threshold” for consistent processing.

At block 315, the computing system performs semantic analysis on the unstructured documents. In some embodiments, the semantic analysis may involve using a language model (e.g., LLM) to extract entities, actions, decision points, and dependencies as described in these documents. For example, in a loan approval policy, the system may extract entities like “Applicant” and “Lender”, tasks like “Check applicant’s credit score” and “Verify applicant’s identity.” The system may further interpret the language to identify decision points, such as “If the credit score is below 650, escalate to manual review; otherwise, approve the loan,” as well as dependencies between certain tasks or actions, such as “Verify income” must be completed before “Assess loan amount eligibility.” The semantic analysis is performed to break down the process described in the unstructured documents into components that can be mapped logically in a structured workflow.

At block 320, the computing system transforms the extracted semantic information (e.g., entities, actions or tasks, decision points, and dependencies) into a vectorized representation. This encoding allows the system to represent the text segments as numerical data in a high-dimensional vector space. The numerical data may capture the semantic relationships and context (e.g., the proximity of related tasks) in a machine-readable format. In the above loan approval example, tasks like “Assess income eligibility” and “Check credit score” may be encoded as closely related vectors because both tasks serve the similar roles in the loan approval process (e.g., validating an applicant’s trustworthiness). Through these vector representations, the system may recognize and process semantically similar elements, even if they are described differently in the unstructured documents.

At block 325, with the vectorized representations, the computing system perform context-aware normalization to create a documented workflow (e.g., 222 of FIG. 2). In some embodiments, this process may include mapping the extracted information into a BPMN format and aligning dependencies to maintain logical flow between tasks. For example, the documented workflow for a loan approval process may include tasks like “Input applicant details,” “Verify income,” and “Check credit score,” with sequential connections added between tasks, such as from “Verify income” to “Check credit score.” If decision point is present, conditional flows may be added into the documented flow. For example, the documented flow for the loan approval process may include a conditional flow like “If credit score > 650, approve loan; otherwise, escalate to manual review.”

After generating the documented workflow, in some embodiments, the computing system may perform a cross-check to validate the workflow (e.g., 222 of FIG. 2) against the original documents. This step is to ensure the generated workflow accurately reflects the process as described in the source material. Any discrepancies or omissions identified during the cross-check may be flagged for manual review and correction. In embodiments where feedback is received from SMEs, the computing system may incorporate the feedback into the workflow to address gaps or ambiguities that may not have been fully resolved during the automated generation process. For example, SMEs may refine the representation of a decision point or clarify dependencies between certain tasks based on their domain expertise. Once the documented workflow is finalized, the computing system may save the workflow in the business process DB (e.g., 220 of FIG. 2).

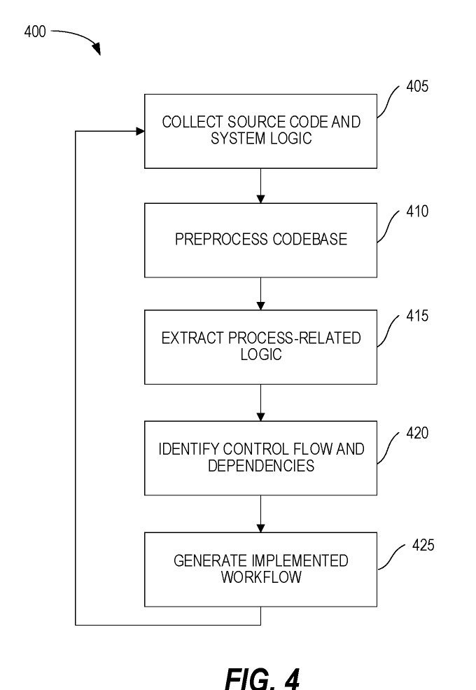

FIG. 4 depicts an example method 400 for generating an implemented workflow for an operational process, according to some embodiments of the present disclosure. In some embodiments, the example method 400 may be performed by any computing devices or systems, such as the computing system 100 as depicted in FIG. 1 or the Code Analysis AI module 214 as depicted in FIG. 2.

At block 405, a computing system collects all relevant source code, configuration files, and system logic that implement a business process (e.g., a loan approval process). This may include identifying modules, scripts, or services directly related to the process being analyzed. For a loan approval process, the collected codebase may include a module for validating applicant identity, scripts and system logic for checking credit scores and financial history, and configuration files specifying thresholds for credit scores or income levels.

At block 410, the collected codebase is preprocessed to prepare the data for subsequent analysis. In some embodiments, the preprocessing may include tasks like cleaning and removing unrelated code segments (e.g., test scripts or unused functions), organizing the codebase into relevant sections, and normalizing the structure to maintain consistency.

At block 415, the computing system processes the codebase and identifies the portions of the codebase that implement the business process (e.g., functions, classes, or workflows). Tools like static code analyzer or domain-specific parsers may be used to isolate the process logic.

At block 420, the computing system analyzes the extracted process-related logic to model the control flow and identify conditions and dependencies between tasks and decision points (e.g., “if-else” or “switch case” statements). For a loan approval process, the system may identify the dependencies, such as “Validating applicant identity” before “Checking credit score,” and the conditional flows, such as “If credit score > 650, approve loan; otherwise, escalate to manual review.”

At block 425, the computing system normalizes the extracted and modeled process logic into a standardized representation, such as BPMN, and generates an implemented workflow (e.g., 224 of FIG. 2). In some embodiments, relevant configuration parameters, such as thresholds or rules (e.g., a credit score threshold of 650 for approval), may be integrated into the implemented workflow. In some embodiments, after the implemented workflow is generated, the computing system may cross-check the workflow against the original codebase to ensure accuracy and completeness. If any discrepancies or omissions are identified during the cross-check, these may be flagged for manual review and correction. In some embodiments, SMEs may provide feedback to the implemented flow, addressing gaps or ambiguities that have not been fully captured during the automated analysis. The feedback may then be incorporated into the implemented workflow, refining the representation of specific decision points and/or updating task dependencies. The finalized implemented workflow may then be saved in the business process DB (e.g., 220 of FIG. 2), where the workflow is available for subsequent vulnerability assessments and comparisons.

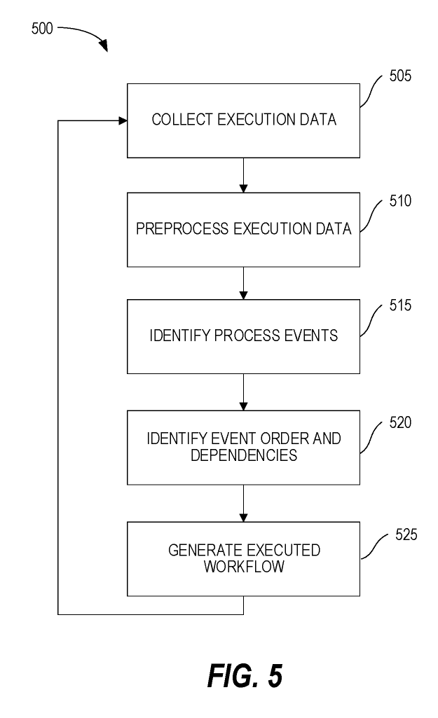

FIG. 5 depicts an example method 500 for generating an executed workflow for an operational process, according to some embodiments of the present disclosure. In some embodiments, the example method 500 may be performed by any computing device or system, such as the computing system 100 as depicted in FIG. 1, or the processing/task mining module 216 as depicted in FIG. 2.

At block 505, a computing system collects execution data for a business process (e.g., loan approval process). The execution data is generated during the real-world operations of the business process. In some embodiments, the execution data may include system logs, timestamps, event traces, user activity logs, transactional records, and any relevant operational metadata that captures the sequence and outcome of executed tasks.

At block 510, the collected execution data is preprocessed to clean and organize the data for further analysis. In some embodiments, the preprocessing may include removing irrelevant or redundant information (e.g., irrelevant logs) and normalizing timestamps or terms to maintain consistency.

At block 515, the computing system analyzes the preprocessed execution data to identify process events. These events may represent the start and end of tasks or actions, as well as decision points within the workflow (e.g., “approved” or “rejected”). For a loan approval process, the events may include “Applicant details submitted,” “Credit score checked,” and “Loan approved” or “Loan rejected.”

At block 520, the computing system determines the sequence order and dependencies among the identified events. This involves reconstructing the flow of the process as it occurred during execution, including any conditions or prerequisites for tasks. The sequence for a loan approval process may be as follows: “Applicant details submitted” “Applicant identity validated” “Credit score checked” ”Decision: loan approved.”

At block 525, with the events and their sequence order and dependencies identified, the computing system generates a structured executed workflow (e.g., 226 of FIG. 2) for the business process. The executed workflow may be in a standardized format like BPMN. The executed workflow represents how the business process is implemented in real-world scenarios. For example, the executed workflow for a loan approval process may include tasks such as “Applicant details submitted,” “Applicant identity validated,” “Credit score checked,” along with conditional paths for decision like “Approved” or “Rejected.”

In some embodiments, the executed workflow may be cross-verified against the raw execution data. Discrepancies or missing details may then be flagged for review and correction. In some embodiments, SMEs may review the executed workflow to address any ambiguities or inaccuracies that automated analysis may have missed. Their feedback may be incorporated to refine the executed workflow further. In some embodiments, the finalized executed workflow may be stored in the business process DB (e.g., 220 of FIG. 2), along with the documented and implemented workflows for subsequent vulnerability assessment.

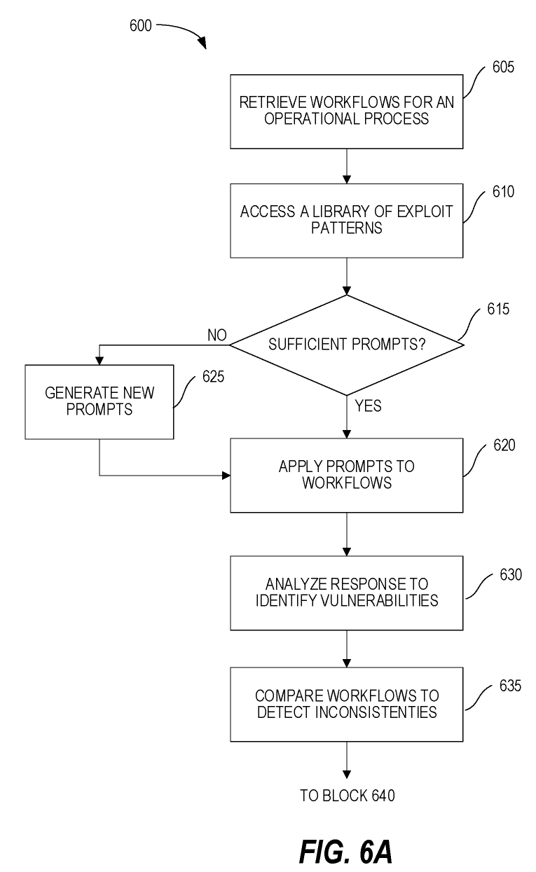

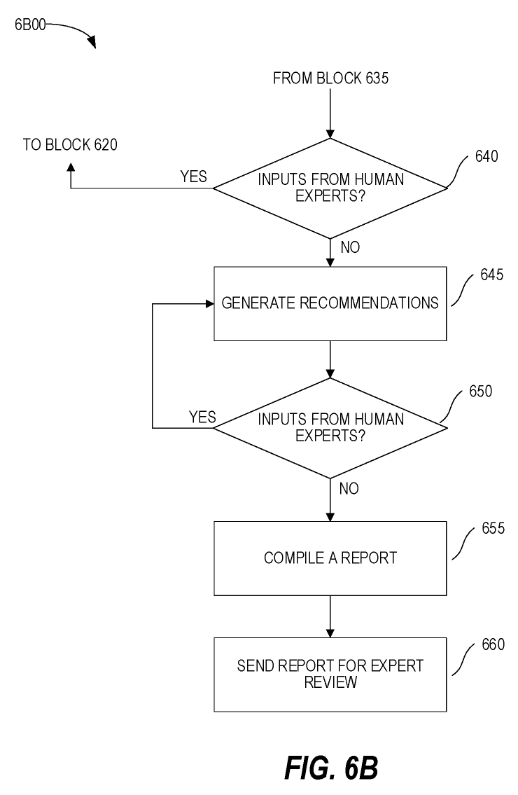

FIGS. 6A and 6B depict an example method 600 for identifying vulnerabilities and inconsistencies in received workflows and generating reports with recommended actions, according to some embodiments of the present disclosure. In some embodiments, the example method 600 may be performed by any computing device or system, including the computing system 100 as depicted in FIG. 1.

At block 605, a computing system retrieves the documented workflow (e.g., 222 of FIG. 2), implemented workflow (e.g., 224 of FIG. 2), and executed flow (e.g., 226 of FIG. 2) for a specific business process (e.g., a loan approval process) from the business process DB (e.g., 220 of FIG. 2).

At block 610, the computing system accesses a library of exploit patterns (e.g., 240 of FIG. 2). The library of exploit patterns contains a wide range of prompts designed to interrogate workflows to identify potential issues or risks within various types of business processes. These prompts may be crafted using generative AI models (e.g., LLM) based on expert inputs. Examples of prompts include: “What is the clip level for loan approvals?” “How many approvals are within 5% below the clip level?” and “Any rollback condition consistently applied across workflows?”

At block 615, the computing system evaluates whether the library contains sufficient prompts for the specific business process being analyzed (e.g., the loan approval process). The prompts in the library are prebuilt based on known risks or common issues encountered in similar processes. For example, risks such as improperly configured approval thresholds and incomplete validation steps may already have associated prompts. However, for some business or operational processes, such as those that are highly specialized or domain-specific or involve newly introduced scenarios, there may be insufficient prebuilt prompts in the library, as the associated risks have not yet been systematically identified or documented.

If there are sufficient prebuilt prompts in the library for the business process being examined, the method 600 proceeds directly to block 620. If the library does not have sufficient prompts, the method 600 moves to block 625, where the system generates new prompts for the business process. In some embodiments, the new prompts may be generated using a GenAI model (e.g., LLM) based on inputs provided by SMEs. In some embodiments, within the inputs, the experts may detail known or suspected risks or concerns for a specific business process. Examples of the input may include “Manual steps often lead to errors” or “Approval threshold vary across different regions.” The inputs may also include operational goals to guide the AI model generating meaningful prompts, such as “Ensure consistency in loan approval criteria.” With these inputs, the GenAI model uses its trained knowledge to interpret the risks and issues described. In some embodiments, the GenAI model may identify patterns from similar use cases in its training data, such as common vulnerabilities in workflows or business operations. Based on these identified risks and patterns, the model may generate targeted prompts designed to systematically probe the retrieved workflows. Various techniques may be used in generating the new prompts, including but not limited to static list, interview-based prompt techniques, chain of thought, and/or tree of thought. Once generated, the newly created prompts are validated and saved into the library of exploit patterns (e.g., 240 of FIG. 2) for future use.

At block 620, the computing system uses the available prompts to probe the retrieved workflows (documented, implemented, and executed). Each prompt is executed against the workflows to simulate queries and generate responses based on the information encoded in each workflow. With the generated responses for each applied prompt, at block 630, the computing system analyzes the responses to identify specific vulnerabilities, gaps, or exploits. This may involve assessing whether specific controls or validations are consistently applied across workflows and identifying tasks, conditions, or dependencies that are omitted or inadequately implemented (e.g., insufficient validation steps or improperly configured thresholds). For a loan approval process, the system may detect that the applicant’s identity validation process is improperly configured. For example, the specified combination of documents for validation may be obtained through publicly available sources. Additionally, the system may detect the identity validation process is not properly executed in practice, such as skipping the step of verifying the applicant’s possession of the register phone number, or accepting identity validation requests where the phone number did not belong to the applicant.

At block 635, the system compares the retrieved workflows (documented, implemented, and executed) to detect discrepancies. This may involve detecting mismatches between the designed workflow (e.g., 222 of FIG. 2) and the implemented (e.g., 224 of FIG. 2) or executed workflow (e.g., 226 of FIG. 2). For example, in a loan approval process, the analysis may reveal that credit score thresholds are inconsistently enforced between the documented and implemented workflows, which creates potential for manual overrides without proper validation. Also, in some embodiments, the documented workflow for a loan approval process may specify a step for “collateral valuation,” which requires the pledged asset to be appraised by a qualified third-party appraiser or an automated valuation tool. The system may detect that the “collateral valuation” step is omitted entirely or inadequately performed in the implemented workflow, such as when the code lacks functionality to trigger the valuation process.

Turning now to FIG. 6B, at block 640, with the inconsistencies and vulnerabilities identified, the computing system checks whether there are additional inputs from human experts (e.g., SMEs in security, compliance, or operations). In some embodiments, after initial vulnerabilities are detected, the human experts may propose new prompts to explore these detected vulnerabilities in greater depth. For example, if the initial analysis reveals that the identity validation process in a loan approval workflow is improperly configured, new prompts may be generated to investigate further: “How often are validation steps skipped for returning customers?” and “What percentage of identity validations rely on publicly accessible data source?” By probing deeper in these areas, the system may uncover additional risks or edge cases that are not apparent within the original set of prompts.

If there are inputs from human experts, such as new prompts, the method 600 moves back to block 620 of FIG. 6A, where the new prompts are incorporated, and the computing system applies these new prompts to the retrieved workflows, generates new responses, and performs another round of analysis to detect vulnerabilities or exploits (that have not been unaddressed in previous analysis). If no inputs are received from human experts, the method 600 directly moves to block 645.

At block 645, the computing system generates detailed recommendations based on the detected inconsistencies and vulnerabilities. In some embodiments, the recommendations actions may include remedial actions (e.g., 252 of FIG. 2) and monitoring actions (e.g., 250 of FIG. 2). The remedial actions may include actions to correct inconsistencies, such as aligning the implemented or executed workflow with the documented workflow, and address vulnerabilities identified during the analysis, such as redefining loan approval thresholds or introducing stricter validation steps to prevent exploitation. The monitoring actions may refer to preventive measures designed to detect and respond to potential vulnerabilities or deviations in real time, such as adding logging and real-time alert system to track skipped validation steps or unusual workflow patterns.

At block 650, the computing system checks whether human experts have provided inputs (e.g., 256 of FIG. 2) regarding the generated recommendations. In some embodiments, experts may review the recommended actions and refine these actions to better align with operational constraints and regulatory requirements. For example, an SME may adjust the severity of proposed actions (e.g., verifying the applicant’s possession of the register phone number) or add specific controls based on anticipated risks. If inputs are received, the method 600 loops back to block 645, where the computing system incorporates the new inputs and refines the recommendations accordingly. If no inputs are received, the method 600 moves to block 655 for report compilation.

At block 655, the computing system compiles the finalized recommendations (e.g., remedial actions or monitoring mechanisms) into a structured report (e.g., 254 of FIG. 2). In some embodiments, the report may also include a summary of risk uncovered during the analysis (e.g., the detected vulnerabilities or inconsistencies), along with their potential impacts. The report serves as a comprehensive records of the analysis and includes remedial actions recommended for stakeholders. In some embodiments, the computing system may categorize the detected vulnerabilities based on their severity, type, or scope of impact. The severity refers to the potential impact or consequence caused by the vulnerability, such as financial loss, fraud, or regulatory non-compliance. The type refers to the nature of the issue, such as skipped validation steps, improper configurations, or manual workarounds. The scope of impact refers to the extent to which the vulnerability affects the overall operational process, interconnected workflows, or broader organizational objectives. Based on these categories, the system may prioritize the recommended actions in the report. For example, high-severity vulnerabilities, such as improper identity validation that could lead to fraud (e.g., in a loan approval process), may be flagged for immediate remediation (e.g., marked in red). Lower-priority issues, such as minor inefficiencies in workflow execution, may be scheduled for future process improvements (e.g., marked in orange or yellow).

At block 660, the computing system sends the report to a remote device for review by human expert or other stakeholders (e.g., process manager, security analysts). The report may be send as a file (e.g., PDF or other structured format) or a notification (e.g., email, text message, or messaging platform) through secure communication channels to the recipient’s device (e.g., computer, tablet, or smart phone). In some embodiments, the report may be displayed on the device’s user interface for immediate interaction. In some embodiments, the report may be presented as a series of structured data tables, graphs, or charts on a screen display. In some embodiments, for accessibility or convenience, the report may be presented via audio outputs.

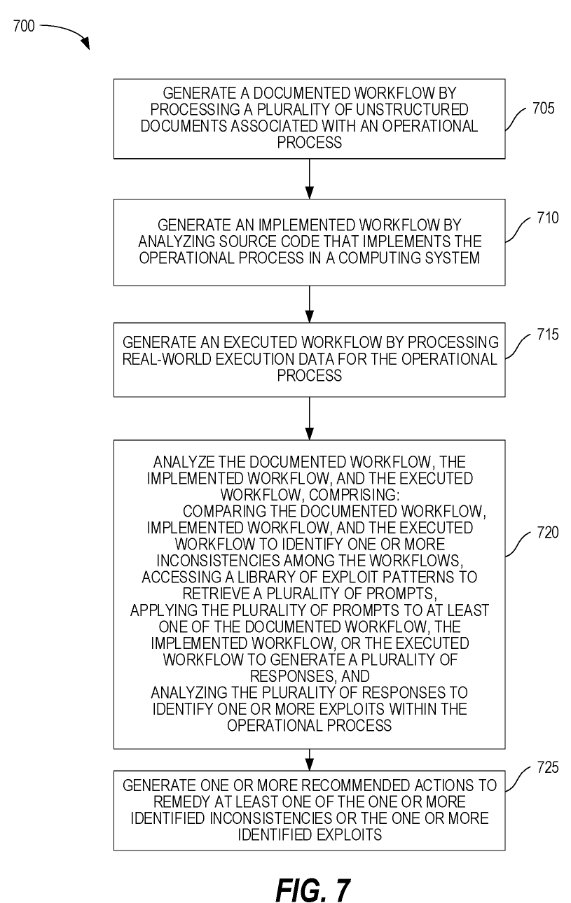

FIG. 7 is a flow diagram depicting an example method 700 for process vulnerability assessment and remedial action recommendation, according to some embodiments of the present disclosure.

At block 705, a computing device generates a documented workflow (e.g., 222 of FIG. 2) by processing a plurality of unstructured documents (e.g., 202 of FIG. 2) associated with an operational process.

At block 710, the computing device generates an implemented workflow (e.g., 224 of FIG. 2) by analyzing source code (e.g., 204 of FIG. 2) that implements the operational process in a computing system.

At block 715, the computing device generates an executed workflow (e.g., 226 of FIG. 2) by processing real-world execution data (e.g., 206 of FIG. 2) for the operational process.

At block 720, the computing device analyzes the documented workflow, the implemented workflow, and the executed workflow, comprising: comparing the documented workflow, implemented workflow, and the executed workflow to identify one or more inconsistencies (e.g., 246 of FIG. 2) among the workflows, accessing a library of exploit patterns (e.g., 240 of FIG. 2) to retrieve a plurality of prompts, applying the plurality of prompts to at least one of the documented workflow, the implemented workflow, or the executed workflow to generate a plurality of responses (e.g., 244 of FIG. 2), and analyzing the plurality of responses to identify one or more exploits within the operational process (e.g., 248 of FIG. 2).

At block 725, the computing device generates one or more recommended actions (e.g., 250 or 252 of FIG. 2) to remedy at least one of the one or more identified inconsistencies or the one or more identified exploits.

In some embodiments, the computing device further generates a report (e.g., 254 of FIG. 2) comprising the one or more identified inconsistencies, the one or more identified exploits, and the one or more recommended actions, and transmits the report to a remote device for expert review.

In some embodiments, the plurality of prompts within the library of exploit patterns may be generated based on one or more inputs (e.g., 230 of FIG. 2) provided by subject matter experts, and the plurality of prompts may be generated automatically using techniques comprising at least one of static lists, interview-based prompts, chain of thought techniques, and tree of thought techniques.

In some embodiments, the recommended actions may comprise at least one of steps (e.g., 252 of FIG. 2) to resolve the one or more identified inconsistencies or the one or more identified exploits across the documented workflow, the implemented workflow, and the executed workflow, or detection and monitoring mechanisms (e.g., 250 of FIG. 2) to prevent future exploitation of the operational process.

In some embodiments, the library of exploit patterns may be dynamically updated, the updating comprising: generating a new prompt based on at least one of the one or more identified exploits or the one or more identified inconsistencies for the operational process, and saving the new prompt in the library of exploit patterns (e.g., 240 of FIG. 2).

In some embodiments, the documented workflow may be normalized into a structured format, comprising a business process model and notation (BPMN) format.

In some embodiments, the computing system may classify the identified one or more exploits into one or more categories, where the categories are based on at least one of severity, type, or scope of impact, and prioritize the one or more recommended actions based on the categories.

In some embodiments, the documented workflow, the implemented workflow, and the executed workflow are stored in an operational process database (e.g., business process DB 220 of FIG. 2).

In some embodiments, the process of applying the plurality of prompts to at least one of the documented workflow, the implemented workflow, or the executed workflow to generate the plurality of responses comprises using a modular reasoning, knowledge, and language (MRKL) system, the MRKL system comprising: a knowledge module to retrieve the documented workflow, the implemented workflow, and the executed workflow from the operational process database, and retrieve the plurality of prompts from the library of exploit patterns, a reasoning module to analyze the workflows and evaluate the plurality of responses to identify the one or more exploits within the operational process, and a language module to process the plurality of responses and structure the one or more identified exploits into actionable outputs.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
generating a documented workflow by processing a plurality of unstructured documents associated with an operational process;
generating an implemented workflow by analyzing source code that implements the operational process in a computing system;
generating an executed workflow by processing real-world execution data for the operational process;
analyzing the documented workflow, the implemented workflow, and the executed workflow, comprising:
comparing the documented workflow, implemented workflow, and the executed workflow to identify one or more inconsistencies among the workflows,
accessing a library of exploit patterns to retrieve a plurality of prompts,
applying the plurality of prompts to at least one of the documented workflow, the implemented workflow, or the executed workflow to generate a plurality of responses, and
analyzing the plurality of responses to identify one or more exploits within the operational process; and
generating one or more recommended actions to remedy at least one of the one or more identified inconsistencies or the one or more identified exploits.

2. The method of claim 1, further comprising:
generating a report comprising the one or more identified inconsistencies, the one or more identified exploits, and the one or more recommended actions; and
transmitting the report to a remote device for expert review.

3. The method of claim 1, wherein the plurality of prompts within the library of exploit patterns are generated based on one or more inputs provided by subject matter experts, and wherein the plurality of prompts are generated automatically using techniques comprising at least one of static lists, interview-based prompts, chain of thought techniques, and tree of thought techniques.

4. The method of claim 1, wherein the recommended actions comprises at least one of steps to resolve the one or more identified inconsistencies or the one or more identified exploits across the documented workflow, the implemented workflow, and the executed workflow, or detection and monitoring mechanisms to prevent future exploitation of the operational process.

5. The method of claim 1, wherein the library of exploit patterns is dynamically updated, the updating comprising:
generating a new prompt based on at least one of the one or more identified exploits or the one or more identified inconsistencies for the operational process; and
saving the new prompt in the library of exploit patterns.

6. The method of claim 1, wherein the documented workflow is normalized into a structured format, comprising a business process model and notation (BPMN) format.

7. The method of claim 1, further comprising:
classifying the one or more identified exploits into one or more categories, wherein the categories are based on at least one of severity, type, or scope of impact; and
prioritizing the one or more recommended actions based on the categories.

8. The method of claim 1, wherein the documented workflow, the implemented workflow, and the executed workflow are stored in an operational process database.

9. The method of claim 8, wherein applying the plurality of prompts to at least one of the documented workflow, the implemented workflow, or the executed workflow to generate the plurality of responses comprises using a modular reasoning, knowledge, and language (MRKL) system, the MRKL system comprising:
a knowledge module to retrieve the documented workflow, the implemented workflow, and the executed workflow from the operational process database, and retrieve the plurality of prompts from the library of exploit patterns;
a reasoning module to analyze the workflows and evaluate the plurality of responses to identify the one or more exploits within the operational process; and
a language module to process the plurality of responses and structure the one or more identified exploits into actionable outputs.

10. A system, comprising:
one or more memories collectively containing one or more programs; and
one or more processors, wherein the one or more processors are configured to, individually or collectively, perform an operation comprising:
generating a documented workflow by processing a plurality of unstructured documents associated with an operational process;
generating an implemented workflow by analyzing source code that implements the operational process in a computing system;
generating an executed workflow by processing real-world execution data for the operational process;
analyzing the documented workflow, the implemented workflow, and the executed workflow, comprising:
comparing the documented workflow, implemented workflow, and the executed workflow to identify one or more inconsistencies among the workflows,
accessing a library of exploit patterns to retrieve a plurality of prompts,
applying the plurality of prompts to at least one of the documented workflow, the implemented workflow, or the executed workflow to generate a plurality of responses, and
analyzing the plurality of responses to identify one or more exploits within the operational process; and
generating one or more recommended actions to remedy at least one of the one or more identified inconsistencies or the one or more identified exploits.

11. The system of claim 10, wherein the operation further comprises:
generating a report comprising the one or more identified inconsistencies, the one or more identified exploits, and the one or more recommended actions; and
transmitting the report to a remote device for expert review.

12. The system of claim 10, wherein the plurality of prompts within the library of exploit patterns are generated based on one or more inputs provided by subject matter experts, and wherein the plurality of prompts are generated automatically using techniques comprising at least one of static lists, interview-based prompts, chain of thought techniques, and tree of thought techniques.

13. The system of claim 10, wherein the recommended actions comprises at least one of steps to resolve the one or more identified inconsistencies or the one or more identified exploits across the documented workflow, the implemented workflow, and the executed workflow, or detection and monitoring mechanisms to prevent future exploitation of the operational process.

14. The system of claim 10, wherein the library of exploit patterns is dynamically updated, the updating comprising:
generating a new prompt based on at least one of the one or more identified exploits or the one or more identified inconsistencies for the operational process; and
saving the new prompt in the library of exploit patterns.

15. The system of claim 10, wherein the documented workflow is normalized into a structured format, comprising a business process model and notation (BPMN) format.

16. The system of claim 10, wherein the operation further comprises:
classifying the one or more identified exploits into one or more categories, wherein the categories are based on at least one of severity, type, or scope of impact; and
prioritizing the one or more recommended actions based on the categories.

17. The system of claim 10, wherein the documented workflow, the implemented workflow, and the executed workflow are stored in an operational process database.

18. The system of claim 17, wherein applying the plurality of prompts to at least one of the documented workflow, the implemented workflow, or the executed workflow to generate the plurality of responses comprises using a modular reasoning, knowledge, and language (MRKL) system, the MRKL system comprising:
a knowledge module to retrieve the documented workflow, the implemented workflow, and the executed workflow from the operational process database, and retrieve the plurality of prompts from the library of exploit patterns;
a reasoning module to analyze the workflows and evaluate the plurality of responses to identify the one or more exploits within the operational process; and
a language module to process the plurality of responses and structure the one or more identified exploits into actionable outputs.

19. One or more computer-readable media containing, in any combination, computer program code that, when executed by a computer system, performs an operation comprising:
generating a documented workflow by processing a plurality of unstructured documents associated with an operational process;
generating an implemented workflow by analyzing source code that implements the operational process in a computing system;
generating an executed workflow by processing real-world execution data for the operational process;
analyzing the documented workflow, the implemented workflow, and the executed workflow, comprising:
comparing the documented workflow, implemented workflow, and the executed workflow to identify one or more inconsistencies among the workflows,
accessing a library of exploit patterns to retrieve a plurality of prompts,
applying the plurality of prompts to at least one of the documented workflow, the implemented workflow, or the executed workflow to generate a plurality of responses, and
analyzing the plurality of responses to identify one or more exploits within the operational process; and
generating one or more recommended actions to remedy at least one of the one or more identified inconsistencies or the one or more identified exploits.

20. The one or more computer-readable media of claim 19, wherein the operation further comprises:
generating a report comprising the one or more identified inconsistencies, the one or more identified exploits, and the one or more recommended actions; and
transmitting the report to a remote device for expert review.
